(19) United States
(12) Patent Application Publication
(10) Pub. No.: US 2005/0015341 A1
(43) Pub. Date: Jan. 20, 2005

(54) Process and method for identifying and processing returned checks

(76) Inventor: Walter C. Jackson, Carrollton, TX (US)

Correspondence Address: THE LAW OFFICE OF STEPHEN R. LOE, P.O. Box 649, Frisco, TX, 75034, US

(21) Appl. No.: 10/609,919

(22) Filed: Jun. 30, 2003

(51) Int. Cl. G06F 17/60

(52) U.S. Cl. 705/45; 705/35

(57) ABSTRACT

A method, system, and computer program product for processing checks is provided. In one embodiment, a plurality of checks from a variety of banks of first deposit are fed through a reader/sorter. The magnetic ink character recognition data is captured from one of the plurality of checks. Alternatively, a check image is received from a bank and the magnetic ink character recognition data is determined from the check image. The magnetic ink character recognition data is compared to stored bank data to determine whether the check should be returned to a bank of first deposit. Responsive to a determination that the check does not match return criteria specified in the stored bank data, the check is posted to a demand deposit account. Responsive to a determination that the check does match return criteria specified in the stored bank data, a return to the bank of first deposit procedure is initiated.

### BACKGROUND OF THE INVENTION

1. Technical Field

The present invention relates generally to document processing and, more specifically, to returned check processing for banking industries.

2. Description of Related Art

One important aspect of banking is identifying returnable checks. A typical prior art process for identifying returnable checks is depicted in FIG. 1. This process for identifying returnable checks is a tedious process and usually takes place in the early morning hours after the checks 102 have been captured on a reader/sorter 104, rejects repaired, balanced and posted 106 to the customer accounts commonly referred to as Demand Deposit Accounts (DDAs) 108. Once the posting 106 update is completed, the DDA software identifies checks that meet certain predetermined criteria that may make them un-payable and cause them to be returned to the bank of first deposit. A file of these items is created, called a suspect file 110, and downloaded to the check processing systems.

The checks 102 are again put through the reader/sorter 104 where the Magnetic Ink Character Recognition (MICR) data from the check is compared to the account data on the suspect file. When a match is found, the item is sent to a specific pocket on the reader/sorter. The suspect checks are removed 116 from the pocket and forwarded to a department that makes decisions to pay or not to pay. Some of the items such as stop Pay or Account Closed items require no decision since by definition, they must be returned. We refer to these items as Non-discretionary” returns since they are returned based on the definition of the return criteria and require no human decisions. Once these decisions are made, the operator will then prepare the items for return according to bank procedures 112. Once this process is completed they are distributed 114 to the banks of first deposit.

This is a time consuming and costly process. Therefore, it would be desirable to have a method and system that speeds up identifying returnable checks to reduce the time and expense factors involved in the process thereby improving the profitability of banks and other similar financial institutions.

### SUMMARY OF THE INVENTION

The present invention provides a method, system, and computer program product for processing checks. In one embodiment, a plurality of checks from a variety of banks of first deposit are fed through a reader/sorter. The magnetic ink character recognition (MICR) data is captured from one of the plurality of checks. Alternatively, a check image and MICR data is received from a bank of first deposit. The MICR data is compared to stored bank data to determine whether the check should be returned to a bank of first deposit. Responsive to a determination that the check does not match return criteria specified in the stored bank data, the check is posted to a demand deposit account (DDA). Responsive to a determination that the check does match return criteria specified in the stored bank data, a return to the bank of first deposit procedure is initiated.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A depicts a typical prior art process for identifying returnable checks;

FIG. 1B depicts a schematic diagram illustrating a non-discretionary return process flow for returning checks in accordance with the present invention;

FIG. 1C depicts a schematic diagram illustrating an exceptions/returns process flow for returning checks in accordance with the present invention;

FIG. 2 depicts a pictorial representation of a distributed data processing system in which the present invention may be implemented;

FIG. 3 depicts a block diagram of a data processing system which may be implemented as a server in accordance with the present invention;

FIG. 4 depicts a block diagram of a data processing system in which the present invention may be implemented;

FIG. 5 depicts a perspective view of a check reader/sorter in accordance with one embodiment of the present invention; and

FIG. 6 depicts a schematic diagram illustrating an exemplary process flow for identifying and returning checks in accordance with one embodiment of the present invention.

### DETAILED DESCRIPTION OF THE PREFERRED EMBODIMENT

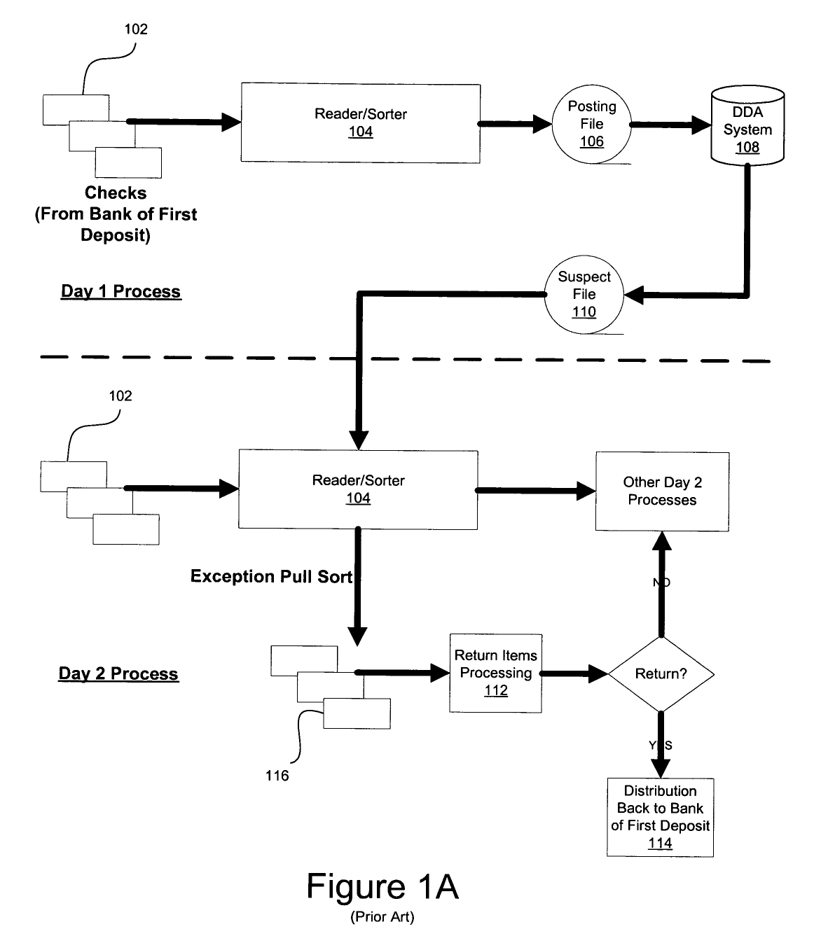

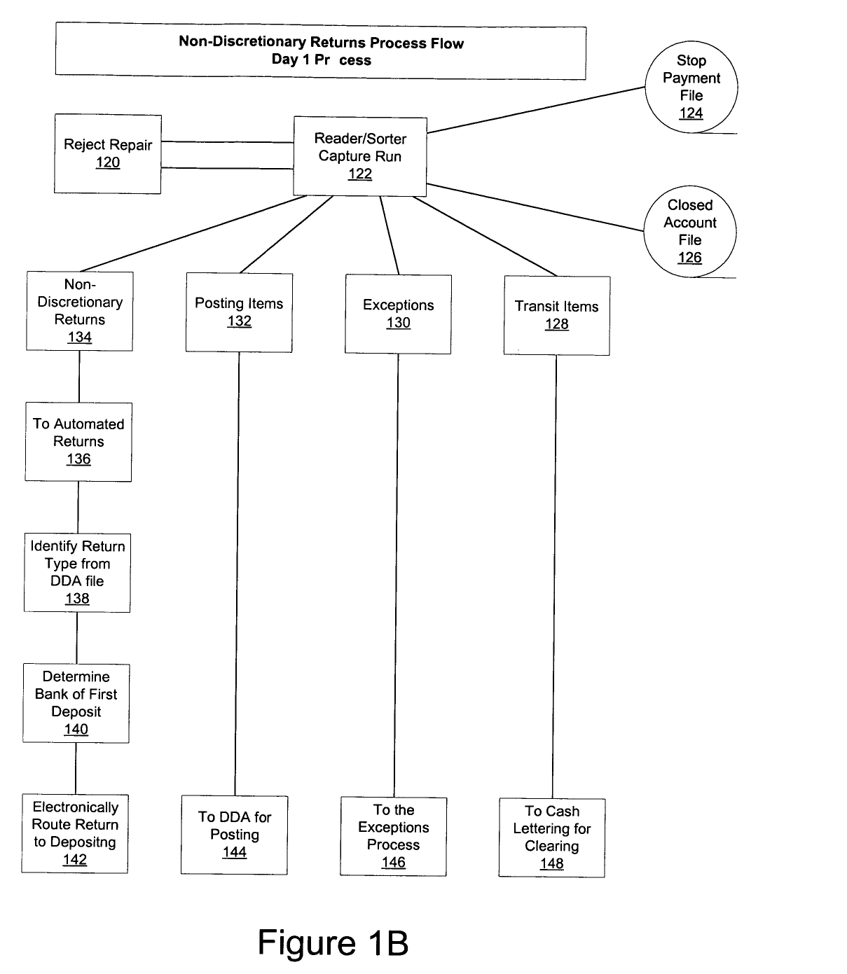

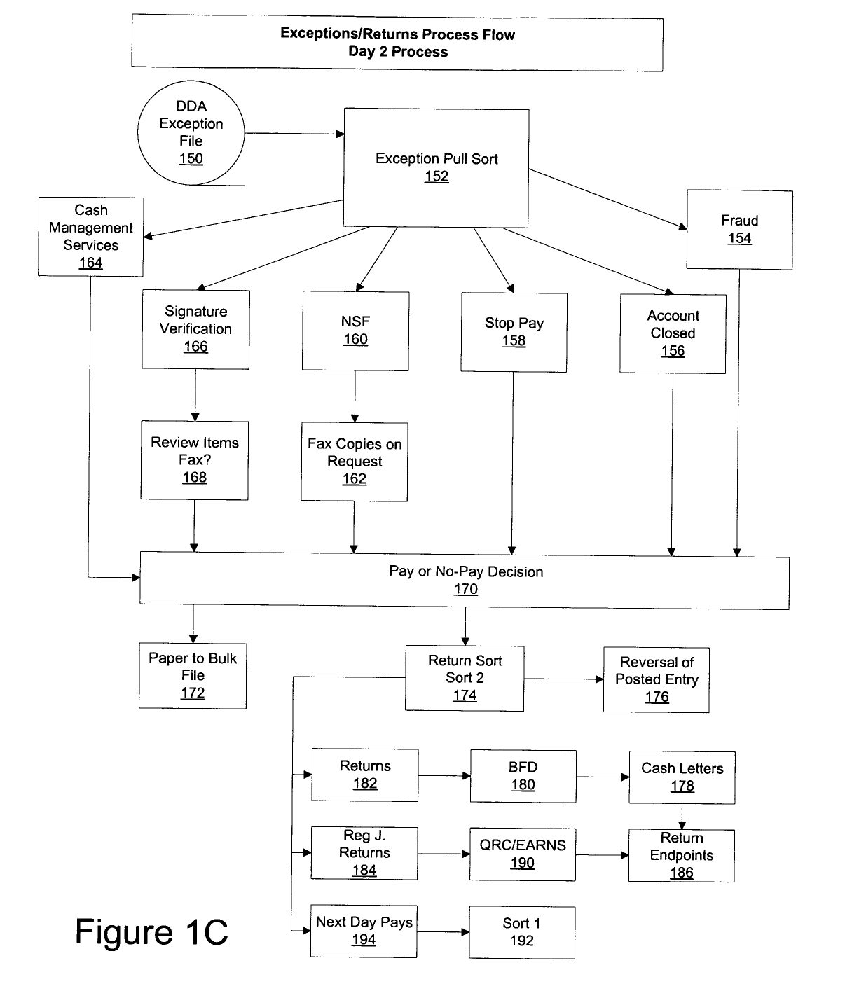

With reference now to the figures, and in particular with reference to FIG. 1B, a schematic diagram illustrating a non-discretionary return process flow for returning checks is depicted in accordance with the present invention. In a non-discretionary returns processing, a reader/sorter capture run 122 captures the Magnetic Ink Character Recognition (MICR) data from each check and sends checks that cannot be read to a reject repair pocket 120. Reject repair 120 returns the checks or their information to the reader/sorter 122. The reader/sorter 122 compares information from the MICR data on a check to files containing non-discretionary check information that may identify a reason checks such as, for example, stop payment instructions 124 and closed account information 126.

Any checks matching the non-discretionary reasons for return are annotated with a return code that identifies the type of criteria that caused the item to be returned and sent as a suspect file to the non-discretionary returns process 134 which routes the checks, based on return code, to the automated returns process 136. Next, the process identifies the return type from the Demand Deposit Account (DDA) file return code 138 and determines the bank of first deposit 140. The system then electronically routes the returned check information to the bank of first deposit 142 and generates transaction entries to make financial entries to the payee account and the bank of first deposit clearing account.

Physical items that match suspect lists are routed from the reader/sorter capture run 122 to an exceptions output pocket 130. These checks are then taken for exceptions processing 146. Items that have been processed through the automated returns process are separated and processes employed to ensure they will not be returned a second time with the physical check. Transit items(Items payable at other banks) 128 are also sorted by the read/sorter capture run 122 and are sent to cash lettering for clearing 148. All other check items are routed by reader/sorter capture run 122 to posting items 132. These checks are then sent to DDA for posting to the appropriate customer's DDA bank account 144. Thus, the present system for processing checks identifies a significant percentage of returnable checks during the first primary pass of the reader/sorter, thereby enabling the bank of first deposit to be notified sooner that a check is being returned.

With reference now to FIG. 1C, a schematic diagram illustrating an exceptions/returns process flow for returning checks is depicted in accordance with the present invention. After the primary pass through the reader/sorter as described above, an exceptions items flow is processed, typically on day two. The checks identified by the DDA Exception File 150 on the initial prime pass have an exception pull sort process performed 152. The traditional Exception pull sort 152 uses the output file from the DDA process to outsort all items that appear on that file. This file contains all suspect items for all exception types some portion of which may be returned. There may also be items outsorted that require special handling for certain bank customers. These processes include the cash management services 164, signature verification items 166, checks to be returned for insufficient funds (NSF) 160, and checks for fraud evaluation 154, and other items that the bank deems it necessary to scrutinize more closely or for customer service delivery. In the prior art, stop pay 158 and account closed 156 checks were made as well. However, such non-discretionary items in the present invention are now processed during the prime pass, thus leveling the workload by taking these items out of the exception item pull sort processing.

The exception returns flow may review items 168 for signature verification 166 and for NSF processing. Once the various exception pull sort reviews 154-168 have been performed, a pay or no-pay decision 170 is made. Items that are to be paid are sent to the bulk file 172. Items that are not to be paid are sent to the return sort 174 for reversal of posted entry 176 and separated into various categories such as, for example, returns 180, Reg J returns 182, and next day pays 194. Other processing 178, 180, 186, 190, and 192 may then be performed.

Thus, it is apparent that the present invention, by eliminating the need for non-discretionary returns to be processed through the exception pull sort significantly reduces the workload on the system.

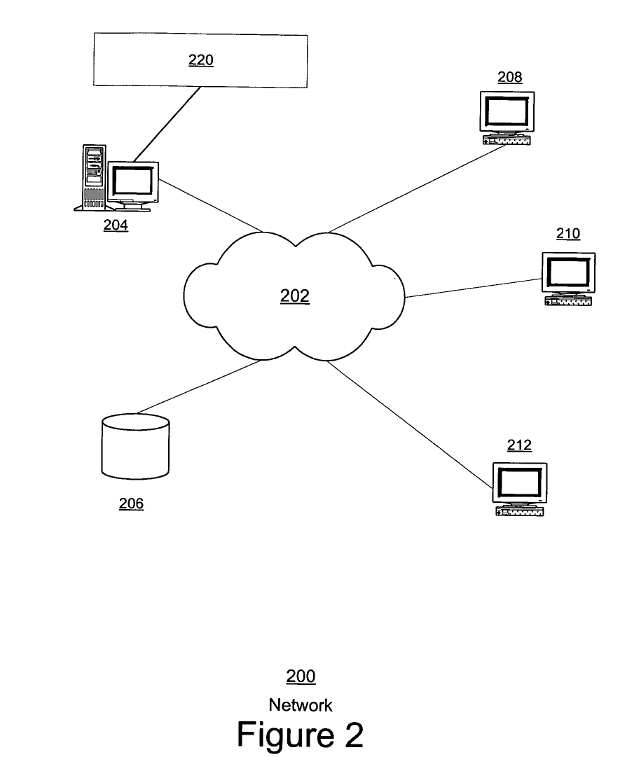

With now reference to FIG. 2, a pictorial representation of a distributed data processing system is depicted in which the present invention may be implemented. Distributed data processing system 200 represents one embodiment of the hardware components for a check processing service.

Distributed data processing system 200 is a network of computers in which the present invention may be implemented. Distributed data processing system 200 contains network 202, which is the medium used to provide communications links between various banks' and other financial institutions' and service providers' devices and computers connected within distributed data processing system 200. Network 202 may include permanent connections, such as wire or fiber optic cables, or temporary connections made through telephone connections.

In the depicted example, check processing service provider server 204 is connected to network 202, along with storage unit 206. Server 204 is also connected to a check reader/sorter 220. In addition, bank clients 208, 210, and 212 are also connected to network 202. These clients, 208, 210, and 212, may be, for example, personal computers, other servers, or network computers. For purposes of this application, a network computer is any computer coupled to a network that receives a program or other application form another computer coupled to the network. In the depicted example, check processing service receives checks from client banks and processes the checks to determine the amount, route the checks to the proper bank, and provide account reconciling information to each bank through clients 206-210. Physical checks received from the banks are processed through check reader/sorter 220 which reads the Magnetic Ink Character Recognition (MICR) data from each check, captures an image of each check and sorts the check to an appropriate receiving bin. Server 204 may also receive images of checks that from any one of clients 208, 210, and 212 that have previously been scanned by the individual banks. Thus, clients 208, 210, and 212 are clients to server 204 and represent member banking or other financial institutions which utilize the check processing services of bank services server 204. Distributed data processing system 200 may include additional servers, clients, and other devices not shown.

After the reader/sorter 220 scans the MICR data from each check, the reader/sorter 220 sends the data to server 204 which compares the MICR data to bank data stored in data storage 206. The bank data is received from individual bank clients 208-212 via network 202 and includes predetermined non-discretionary criteria that prohibit a check from being posted to a customer account as well as other data useful for check processing. If the MICR data matches bank data that indicates that the check may not be posted to a customer's account and must be returned, the server 204 sends instructions to reader/sorter 220 indicating that the check must be returned and instructing the reader/sorter to route the check to the proper output bin for return to the original banking institution of first deposit. Server 204 also electronically sends a message to the appropriate bank client computer 208-212 indicating that the check is being returned, the reason code for the return and any other appropriate header and footer data that may be desired. Server 204 also sends a message indicating the check was returned to the appropriate bank client 208-212 corresponding to the bank on which the check was written. This message also indicates the identity of the check and return reason code as well as any other information that may be desired in the particular implementation and to provide an audit trail.

In some embodiments, rather than receiving physical checks, the check processing service may receive images of checks from some or all of bank clients 208-212. If check images and MICR data are received, server 204 processes the check images in a similar manner to the physical checks. The MICR data from the check images is determined by the server 204 and compared to data in storage unit 206. If the MICR data matches MICR data stored in storage unit 206 that indicates the check is to be returned, then a message is sent to the appropriate bank client 208-212 corresponding to the bank of first deposit indicating the identity of the check, that the check is being returned, the reason code for the return and any other data that is desired in the particular implementation. Furthermore, the appropriate bank client 208-212 corresponding to the bank on which the check is drawn is also sent the same or similar data indicating that the check has been returned.

In some embodiments, no physical checks are received by the check processing service, but only check images. In other embodiments, no check images are received by the check processing service, but only physical checks are received and in still other embodiments, a combination of physical checks and check images are received by the check processing service. However, in each embodiment, the check processing service makes a determination as to whether to return a check during the same processing day as all other check processing procedures are performed, thereby significantly decreasing the time for check processing and increasing profitability for member banking institutions.

In the depicted example, distributed data processing system 200 is the Internet, with network 202 representing a world wide collection of networks and gateways that use, for example, the TCP/IP suite of protocols to communicate with one another. For security purposes, a Virtual Private Network (VPN) could be implemented across network 202 to maintain the integrity and confidentiality of data transmitted between the bank servicing enterprise and the member banks. Furthermore, data sent across network 202 may be encrypted using any of many well known encryption methods. Of course, distributed data processing system 200 also may be implemented as a number of different types of networks, such as, for example, an intranet, a wide area network, or a local area network.

FIG. 2 is intended as an example and not as an architectural limitation for the processes of the present invention.

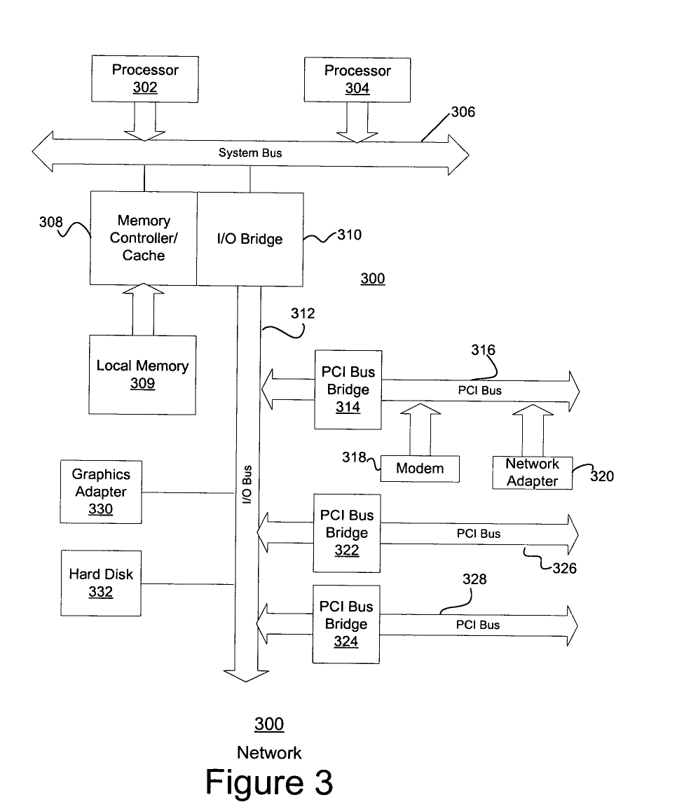

Referring to FIG. 3, a block diagram of a data processing system which may be implemented as a server, such as server 204 in FIG. 2, is depicted in accordance with the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308 which provides an interface to local memory 309. I/O Bus Bridge 310 is connected to system bus 306 and provides an interface to I/O bus 312. Memory controller/cache 308 and I/O Bus Bridge 310 may be integrated as depicted.

Peripheral component interconnect (PCI) bus bridge 314 connected to I/O bus 312 provides an interface to PCI local bus 316. A number of modems 318-320 may be connected to PCI bus 316. Typical PCI bus implementations will support four PCI expansion slots or add-in connectors. Communications links to network computers 208-212 in FIG. 2 may be provided through modem 318 and network adapter 320 connected to PCI local bus 316 through add-in boards.

Additional PCI bus bridges 322 and 324 provide interfaces for additional PCI buses 326 and 328, from which additional modems or network adapters may be supported. In this manner, server 300 allows connections to multiple network computers. A memory mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

Data processing system 300 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries. In addition to the operating system, check processing software is also included on server 300 in order to perform the processes described above with reference to FIG. 2

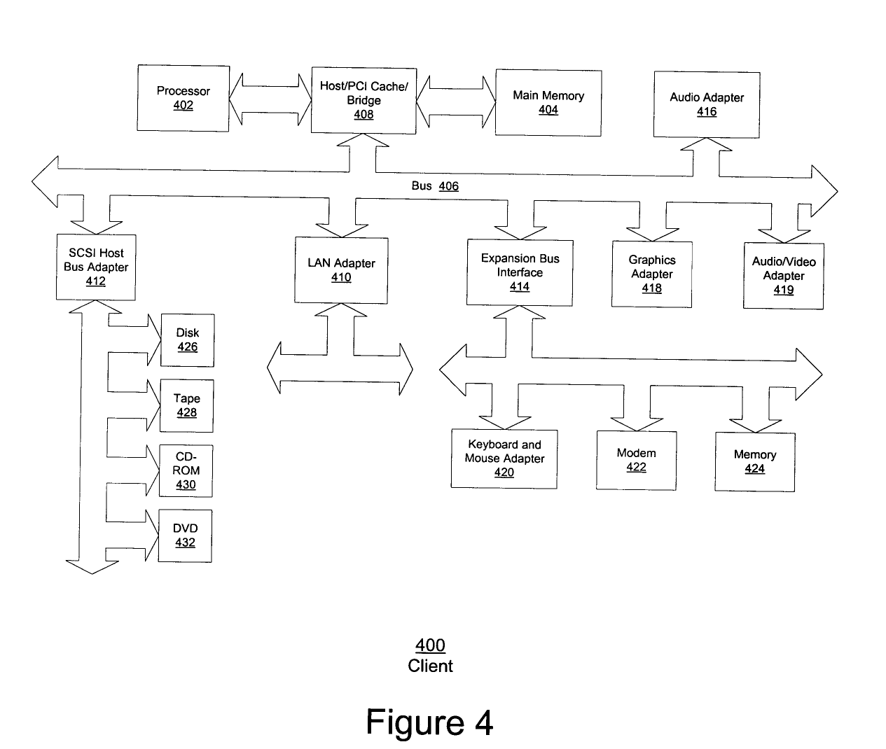

With reference now to FIG. 4, a block diagram of a data processing system in which the present invention may be implemented is illustrated. Data processing system 400 is an example of a client computer. Data processing system 400 employs a peripheral component interconnect (PCI) local bus architecture. Although the depicted example employs a PCI bus, other bus architectures, such as Micro Channel and ISA, may be used. Processor 402 and main memory 404 are connected to PCI local bus 406 through PCI Bridge 408. PCI Bridge 408 may also include an integrated memory controller and cache memory for processor 402. Additional connections to PCI local bus 406 may be made through direct component interconnection or through add-in boards. In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter (A/V) 419 are connected to PCI local bus 406 by add-in boards inserted into expansion slots. Expansion bus interface 414 provides a connection for a keyboard and mouse adapter 420, modem 422, and additional memory 424. In the depicted example, SCSI host bus adapter 412 provides a connection for hard disk drive 426, tape drive 428, CD-ROM drive 430, and digital video disc read only memory drive (DVD-ROM) 432. Typical PCI local bus implementations will support three or four PCI expansion slots or add-in connectors. Additional adapters may be utilized in order to connect data processing system 400 to a check reader/sorter if the banking institution captures images of checks and sends the check images to the check processing service rather than physical checks.

An operating system runs on processor 402 and is used to coordinate and provide control of various components within data processing system 400 in FIG. 4. The operating system may be a commercially available operating system, such as, for example, Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 400. Instructions for the operating system, the object-oriented operating system, and applications or programs are located on a storage device, such as hard disk drive 426, and may be loaded into main memory 404 for execution by processor 402. Additionally, data processing system 400 includes appropriate software for communicating with the check processing server as well as, in some embodiments, accounting software appropriate for banking institutions.

Those of ordinary skill in the art will appreciate that the hardware in FIG. 4 may vary depending on the implementation. For example, other peripheral devices, such as optical disk drives and the like, may be used in addition to or in place of the hardware depicted in FIG. 4. The depicted example is not meant to imply architectural limitations with respect to the present invention. For example, the processes of the present invention may be applied to multiprocessor data processing systems as well.

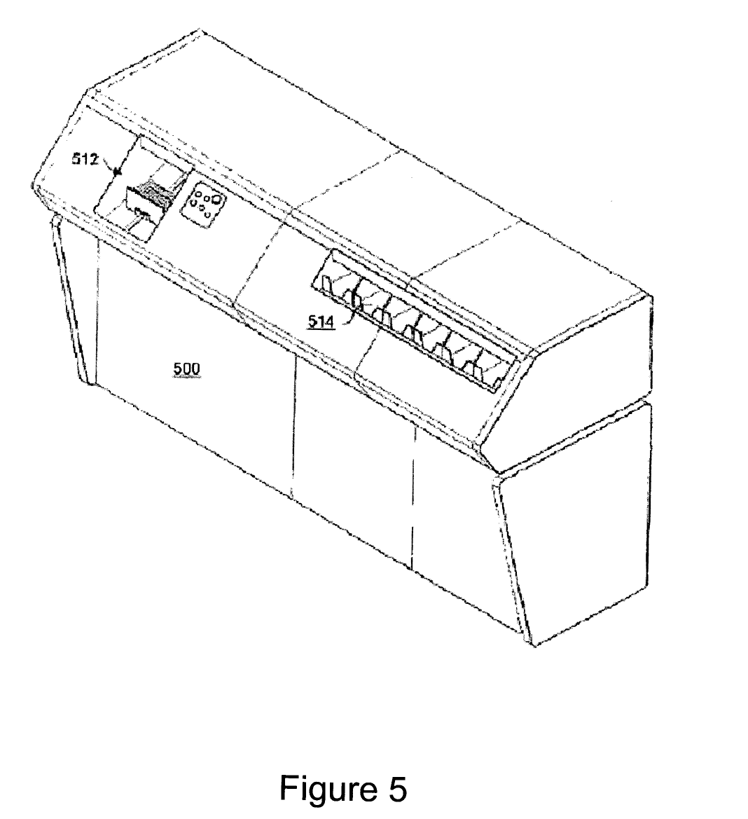

With reference now to FIG. 5, a perspective view of a check reader/sorter which may be implemented as reader/sorter 220 in FIG. 2 is depicted in accordance with one embodiment of the present invention. The reader/sorter 500 is loaded with a batch feed of checks 512 prior to starting the check processing cycle. Single checks are fed from the batch feed of check 512 and then travel on a high-speed conveyor past several different detectors before being deposited in one of several sort bins 514. One or more sort bins may be reserved for return checks. In some embodiments, each banking institution has a bin for returned checks to be collected in. The detectors collect information, including MICR data, from the checks. The information may then be used by the processing machine for accounting purposes, for making check processing determinations, and may be sent to a server, such as server 204 in FIG. 2, for further processing and for determining whether the check should be returned to the bank of first deposit. In addition, reader/sorter 500 receives information from the server, after the server has processed the MICR information, indicating sorting instructions for the particular check. Check processing determinations include separating and sorting the checks according to the bank on which the check is drawn as well as sorting the checks according to returned checks and non-returned checks. For example, at the end of the sort process, a single sort bin (pocket) may be used to accumulate checks that are to be returned for a single return reason code.

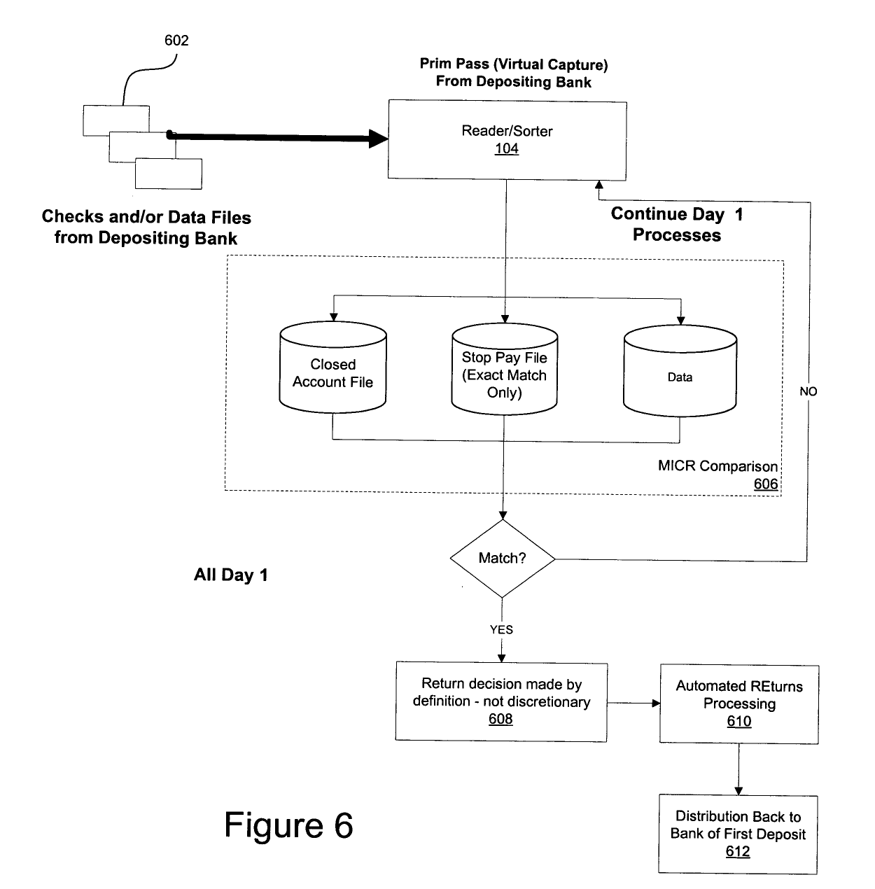

With reference now to FIG. 6, a schematic diagram illustrating an exemplary process flow for identifying and returning checks is depicted in accordance with one embodiment of the present invention. The present invention focuses on checks that cannot be paid by the paying bank due to reasons that do not require a human to make a pay/no-pay decision. The decision to return a check is made by the definition of the return reason which dictates that an item must be returned.

Check items 602 are processed through a reader/sorter 604 and Magnetic Ink character Recognition (MICR) data is captured. The MICR information on the check includes the bank number, account number, check serial number, in addition to the encoded check amount. The checks are read and sorted by bank or some other designation according to the transit and routing information also present in the MICR line. Approximately 1 to 1.5% of checks are rejected because the MICR line information is not readable. The rejected checks are manually handled and the data corrected. The MICR data is compared to exception files 606 to identify check items that by definition must be returned. Examples of return by definition items are closed accounts and stop pay orders. A check whose account number matches a closed account is by definition returned since no account exists with which to pay the amount listed on the check. A stop pay order lists a specific check and account for which a customer has requested to have payment stopped. Again, if a check is identified for which a stop pay order has been issued, the check must be returned by definition. Banks establish return reasons for items that have predetermined criteria, such as those listed above, that prohibits the check items from being posted to a customer account. Certain return types that do not require human interventions to make the return decision can be called Non-Discretionary returns. Commonly, as discussed above, these files are Exact Match Stop Pay, Closed Accounts or other “non-postable” items.

If the check MICR data does not match any data in the MICR comparison storage unit 606 indicating that the check should be returned, then the reader/sorter 604 continues other check processing instructions. If, however, the MICR data does match data in the MICR comparison storage unit 606 indicating that the check should be returned, then the check return decision is made by definition 608, automated check returns processing 610 is initiated, and the check is distributed back to the bank of first deposit 612. Thus, significant time savings is achieved over the prior art, since the prior art's day two processing is incorporated within the prior art's day one processing. Furthermore, the need to feed checks through the reader/sorter twice is eliminated. Earlier identification and return also improves the likelihood that the funds are still in the depository account and can be retrieved by the bank of first deposit.

There are a number of other benefits to be derived from the present invention as well. These benefits include fraud reduction, process cost savings, and workload leveling. Fraud reduction value comes in two forms. One form is due to the fact that return items are frequent causes of write-offs due to the depositing customer fraudulently depositing the check expecting to get the funds and leave the bank holding the bad check. When the item can be identified as a return on prime pass (i.e., first pass) and returned automatically, the bank of first deposit will be notified of returns much sooner, thus lessening their risk of losing the funds. In many situations where the check is deposited at a local bank, the notification of the electronic return can be received before the depositing bank will complete its posting update of DDA accounts. When this occurs, the depositing bank can place a hold on the account for the funds represented by the check and before the updates are released virtually assuring the funds cannot be withdrawn.

The other form of fraud value is in timing. Conventional returns may take up to a week to be received by the bank of first deposit. Expediting this time line to same or at least next day significantly shortens the time the return notice is received and recovery activities can commence.

The present invention also provides process cost savings because the cost of returning a manually processed item is much more expensive than an item returned automatically. This cost differential may be as much as 85% less for the automated process.

The present invention provides workload leveling by taking these items out of the process stream for downstream processes such as Exception Item Pull sort, the sorting run will take less time and make the other work available sooner. Although this new process will only manage about 0.3% of all items processed, that impact will be of value since timing is crucial due to Regulation CC return guidelines. This automated return process also supports the anticipated processes and liabilities around the Check 21 legislation by supporting the electronic clearing processes.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for processing checks, the method comprising:
feeding a plurality of checks from a variety of banks of first deposit through a reader/sorter;
capturing magnetic ink character recognition data from one of the plurality of checks;
comparing the magnetic ink character recognition data to stored bank data to determine whether the check should be returned to a bank of first deposit;
responsive to a determination that the check does not match return criteria specified in the stored bank data, posting the check to a demand deposit account; and
responsive to a determination that the check does match return criteria specified in the stored bank data, initiating a return to bank of first deposit procedure.

2. The method as recited in claim 1, further comprising:
sending information to the bank of first deposit indicating that the check is being returned.

3. The method as recited in claim 2, wherein the information includes a return reason code indicating the reason that the check is being returned.

4. A method for processing checks, the method comprising:
receiving a check image and data from a bank;
determining information from the check image, wherein the information includes bank routing information, bank account information, and check amount information;
comparing the information to stored bank check return data; and
responsive to a determination that the check matches stored bank check return data, sending an indication to the bank from which the check image was received indicating that the check is being returned.

5. The method as recited in claim 4, further comprising:
responsive to a determination that the check does not match stored bank check return data, continuing with check processing and posting.

6. The method as recited in claim 4, wherein the indication includes a return reason code indicating the reason why the check is being returned.

7. A computer program product in a computer readable media for use in a data processing system for processing checks, the computer program product comprising:
first instructions for feeding a plurality of checks from a variety of banks of first deposit through a reader/sorter;
second instructions for capturing magnetic ink character recognition data from one of the plurality of checks;
third instructions for comparing the magnetic ink character recognition data to stored bank data to determine whether the check should be returned to a bank of first deposit;
fourth instructions for determining whether the magnetic ink character recognition data matches return criteria specified in the stored bank data and, responsive to a determination that the check does not match return criteria specified in the stored bank data, posting the check to a demand deposit account; and
fifth instructions for determining whether the magnetic ink character recognition data does not match return criteria specified in the stored bank data and, responsive to a determination that the check does match return criteria specified in the stored bank data, initiating a return to bank of first deposit procedure.

8. The computer program product as recited in claim 7, further comprising:
sixth instructions for sending information to the bank of first deposit indicating that the check is being returned.

9. The computer program product as recited in claim 8, wherein the information includes a return reason code indicating the reason that the check is being returned.

10. A computer program product in a computer readable media for use in a data processing system for processing checks, the computer program product comprising:
first instructions for receiving a check image from a bank;
second instructions for determining information from the check image, wherein the information includes bank routing information, bank account information, and check amount information;
third instructions for comparing the information to stored bank check return data; and
fourth instructions for determining whether the check matches stored bank check return data and, responsive to a determination that the check matches stored bank check return data, sending an indication to the bank from which the check image was received indicating that the check is being returned.

11. The computer program product as recited in claim 10, further comprising:
fifth instructions for determining whether the check does not match the stored bank check return data and, responsive to a determination that the check does not match stored bank check return data, continuing with check processing and posting.

12. The computer program product as recited in claim 10, wherein the indication includes a return reason code indicating the reason why the check is being returned.

13. A system for processing checks, the system comprising:
first means for feeding a plurality of checks from a variety of banks of first deposit through a reader/sorter;
second means for capturing magnetic ink character recognition data from one of the plurality of checks;
third means for comparing the magnetic ink character recognition data to stored bank data to determine whether the check should be returned to a bank of first deposit;
fourth means for determining whether the magnetic ink character recognition data matches return criteria specified in the stored bank data and, responsive to a determination that the check does not match return criteria specified in the stored bank data, posting the check to a demand deposit account; and
fifth means for determining whether the magnetic ink character recognition data does not match return criteria specified in the stored bank data and, responsive to a determination that the check does match return criteria specified in the stored bank data, initiating a return to bank of first deposit procedure.

14. The system as recited in claim 13, further comprising:
sixth means for sending information to the bank of first deposit indicating that the check is being returned.

15. The system as recited in claim 14, wherein the information includes a return reason code indicating the reason that the check is being returned.

16. A system for processing checks, the system comprising:
first means for receiving a check image from a bank;
second means for determining information from the check image, wherein the information includes bank routing information, bank account information, and check amount information;
third means for comparing the information to stored bank check return data; and
fourth means for determining whether the check matches stored bank check return data and, responsive to a determination that the check matches stored bank check return data, sending an indication to the bank from which the check image was received indicating that the check is being returned.

17. The system as recited in claim 16, further comprising:
fifth means for determining whether the check does not match the stored bank check return data and, responsive to a determination that the check does not match stored bank check return data, continuing with check processing and posting.

18. The system as recited in claim 16, wherein the indication includes a return reason code indicating the reason why the check is being returned.
